(19) United States
(12) Patent Application Publication
(10) Pub. No.: US 2015/0103176 A1
(43) Pub. Date: Apr. 16, 2015

(54) MULTI-SCENE MONITORING SYSTEM

(71) Applicant: AmRoad Technology Inc., New Taipei City (TW)

(72) Inventor: Ching-Lin Wu, New Taipei City (TW)

(21) Appl. No.: 14/573,532

(22) Filed: Dec. 17, 2014

Related U.S. Application Data
(63) Continuation-in-part of application No. 13/363,377, filed on Feb. 1, 2012.

(51) Int. Cl. G07C 9/00; G08B 13/196

(52) U.S. Cl. CPC G07C 9/00079; G07C 9/00111; G08B 13/19645
USPC 348/156

(57) ABSTRACT

The objective of the present invention is to provide a multi-scene monitoring system for decreasing the installing cost of the whole system, wherein the monitoring system transmits digital signals through an internet, and an internal communication device, a gate-end operating device, and a card authenticating device only need to connect to the internet without installing concrete wires so as to save a lot of costs in installation and maintenance; moreover, when the monitoring system of the invention applied to a community building, the safety of the community can be increased and the duty of the security can be decreased via the card authenticating device and a visitor token card.

### BACKGROUND OF THE INVENTION

1. Field of the Invention

The present invention relates to a monitoring system, and more particularly to a multi-scene monitoring system.

2. Description of the Prior Art

In this modern society, with the gradually rising life quality, living comfort and convenience, in particular, are indispensables. Therefore, human beings take advantage of the rapidly developed technology to create many inventions for further comforting and facilitating our daily life, and among others, outdoor communication devices would be one typical example. The most primitive outdoor communication devices only allowed for transmit audio messages, and a host cannot recognize the identity of a visitor by viewing the image. Therefore, an audio-type outdoor communication device is able to have great improvement space.

Then, there were inventors bringing up architecture of a video-audio outdoor communication device. Referring to FIG. 1, shows a conventional video-audio outdoor communication device being applied to an apartment building. Wherein a visitor G′ have to use the gate-end operating device 12′ to contact with the host H′ living in the apartment, when the visitor outsides of the lobby gate of the apartment building. Then the host can recognize the identity of the visitor by viewing the image on an internal communication device 11′, wherein the image is shot by the plurality of cameras C′ of the gate-end operating device. After the host check the identity of the visitor, the lobby gate can be opened by operating the internal communication device, and the visitor can walk into the lobby of the apartment.

Furthermore, the visitor can lead by the security in the lobby and open the entrance door and use elevator through the key card of the security so as to reach the level of the host. However the conventional video-audio outdoor communication device usually have following defect and safety risk:

(1) When a criminal pretends a visitor and get into the lobby, the criminal can arrive every level of the apartment by cheating the security and use the key card thereof.

(2) Following the previous, when the criminal attacks the security and get the key card, the criminal can arbitrarily use the elevator or other devices of the apartment through the key card so as to crime.

(3) Otherwise, there are always one or two securities on duty in the lobby, therefore, when the securities need to bring visitors into the apartment, the lobby and the apartment will always be exposed in no guard situation, and cause loopholes in the safety.

In addition, conventional internal communication device 11′ can't display videos shot by community cameras 50 due to privacy considerations, therefore, the members of the community management committee have nowhere to check the videos but the security room. However, the members of the community management committee are householders living in their own house in community instead of the security room, and causing a lot of inconvenience.

Accordingly, in view of the conventional video-audio outdoor communication device still have some shortcomings and drawbacks, the inventor of the present application has made great efforts to make inventive research thereon and eventually provided a multi-scene monitoring system.

### SUMMARY OF THE INVENTION

The objective of the present invention is to provide a multi-scene monitoring system for decreasing the installing cost of the whole system, wherein the monitoring system transmits digital signals through an internet, and an internal communication device, a gate-end operating device, and a card authenticating device only need to connect to the internet without installing concrete wires so as to save a lot of costs in installation and maintenance; moreover, when the monitoring system of the invention applied to a community building, the safety of the community can be increased and the duty of the security can be decreased via the card authenticating device and a visitor token card.

Accordingly, to achieve the objective of the present invention, the inventor of the present invention provides a multi-scene monitoring system comprising:
an internal communication device, being disposed in the internal of one house of the householder, and comprising:
   a first processing unit;
   an data receiving unit, being connected to the first processing unit ;
   a display module, being connected to the data receiving unit;
   a video switching module, being connected to the first processing unit and comprising a switching keyhole for receiving a switching key;
   an indoor communication module, being connected to the first processing unit and providing for a householder to get communication with a visitor; and
   a visitor identity confirming unit;
a warning module, being disposed in the internal of one house of the householder and controlled by the first processing unit to send out warning messages;
a plurality of community cameras, being disposed in the community and connected to the first processing unit via a plurality of activating circuits of the switching keyhole respectively;
a gate-end operating device, being disposed on the outside of a lobby gate of a community, and comprising:
   a second processing unit, being connected to the first processing unit through the internet;
   a driving unit, being connected to the second processing unit for providing the visitor to activate the warning module;
   a gate-end camera module, being connected to the second processing unit for capturing a video of the visitor;
   at least one outdoor camera module, being disposed at a particular position around the lobby gate and connected to the second processing unit of the gate-end operating device; and
   an outdoor communication module, being connected to the second processing unit and providing for the visitor to get communication with the householder; and
a card authenticating device, being disposed in the community and comprising:
   a third processing unit, being connected to the first processing unit through the internet;
   a confirming camera module, being connected to the third processing unit for capturing a video of the visitor;
   a confirming communication module, being connected to the third processing unit and providing for the visitor to get communication with the householder; and
   a token card setting unit, being connected to the third processing unit for setting a plurality of wireless transceiver addresses and a plurality of device IDs in a visitor token card;
wherein the switching key comprises at least one peak, accordingly, the switching keyhole comprises at least one sliding block, moreover, the sliding block is formed with a connecting bar for connecting and conducting the activating circuits;
wherein when the switching key is inserted into the switching keyhole and turned, the peak of the switching key can push the sliding blocks to a particular position so as to connecting the connecting bar and all of the activating circuits, therefore, the householder can watch and switch all videos shot by community cameras based on the activating circuit, wherein the visitor can get the guest token card from a lobby counter of the community after entering the lobby;
wherein when the visitor is allowed to operate the card authenticating device through the visitor token card, the visitor can get communication with the householder via the confirming communication module; such that the householder can confirm the identity of the visitor through the internal communication device; therefore, the householder can set at least one wireless transceiver address and at least one device ID in the visitor token card by operating the visitor identity confirming unit of the internal communication device; eventually, the visitor is allowed to use a plurality of community public equipment based on the wireless transceiver address and the device ID set in the visitor token card.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 illustrates a schematic diagram of a conventional video-audio outdoor communication device being applied to an apartment building;

FIG. 2 illustrates an architectural diagram of the multi-scene monitoring system provided by the present invention;

FIG. 3A, FIG. 3B, and FIG. 3C illustrate a schematic diagram of the monitoring system applied in a community;

FIG. 4 illustrates a stereo view of the internal communication device of the present invention;

FIG. 5A, FIG. 5B, and FIG. 5C illustrate a schematic diagram of the operation of the switching key and the switching keyhole; and

FIG. 6A and FIG. 6B illustrate a schematic diagram of the operation of the switching key and the switching keyhole of the implemental embodiment.

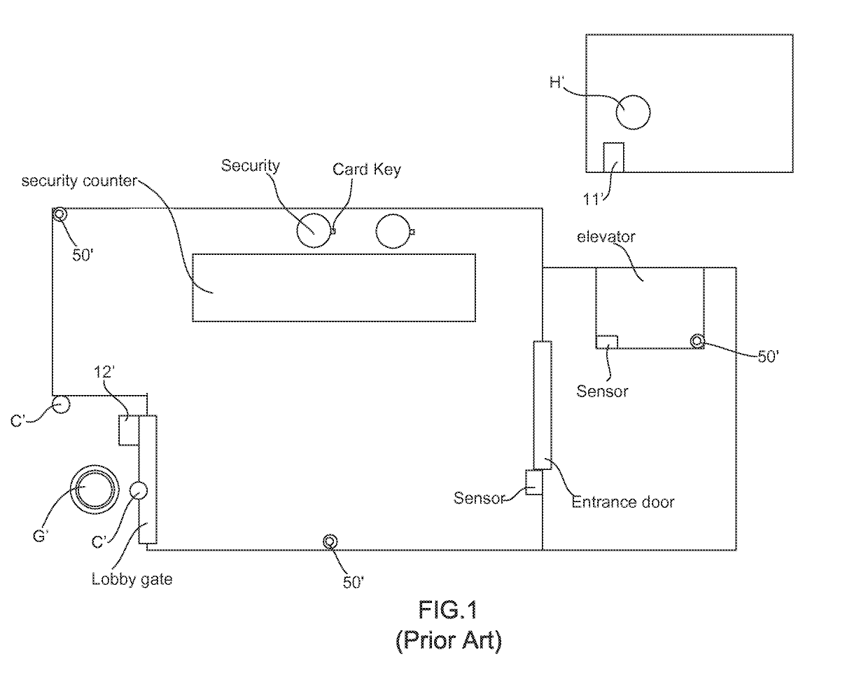

### DETAILED DESCRIPTION OF THE PREFERRED EMBODIMENTS

To more clearly describe a multi-scene monitoring system provided by the present invention, embodiments of the present invention will be described in detail with reference to the attached drawings hereinafter.

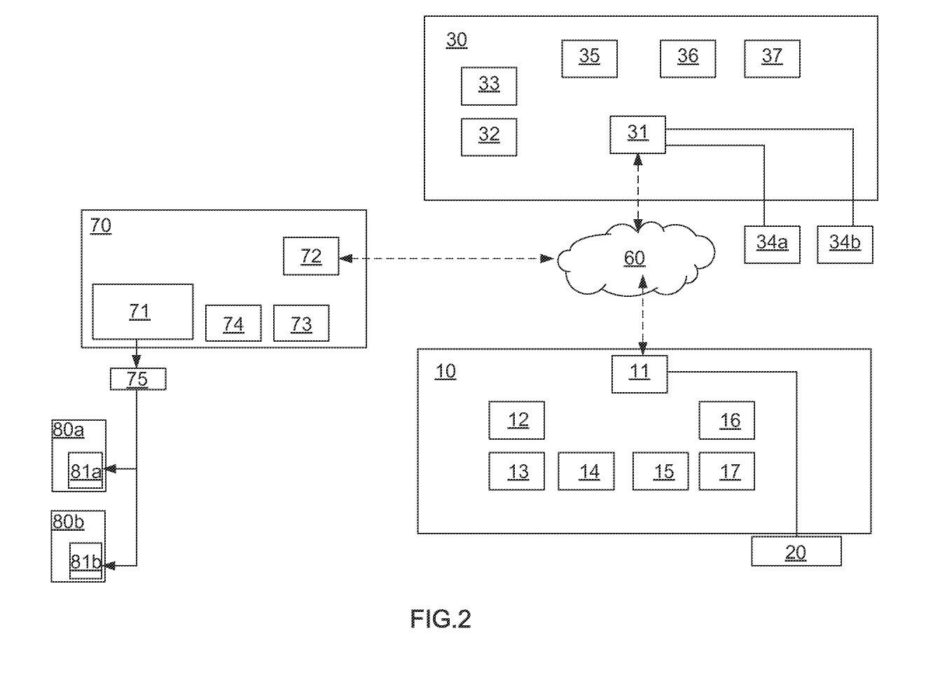

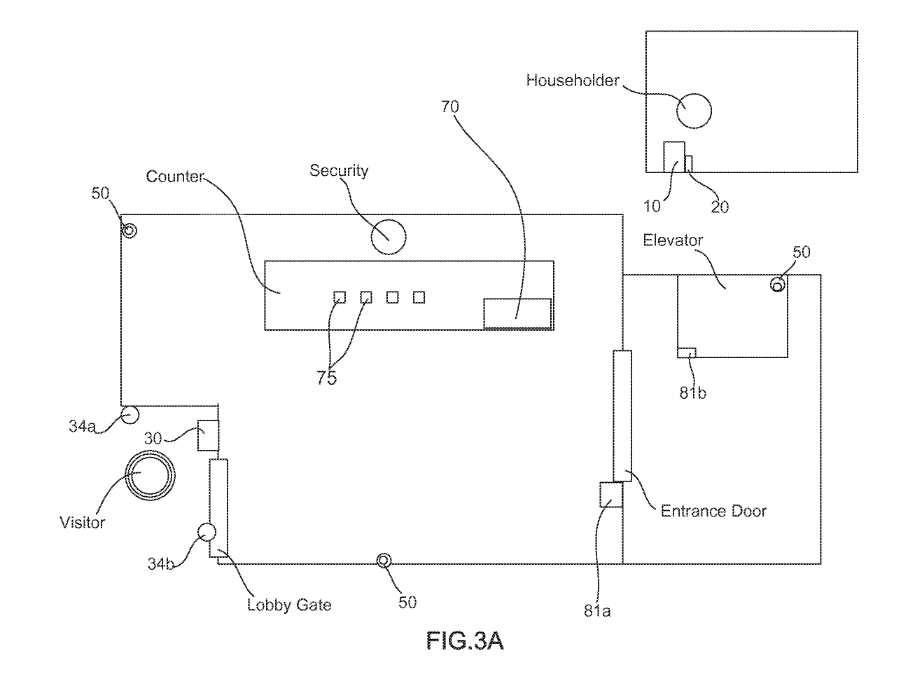

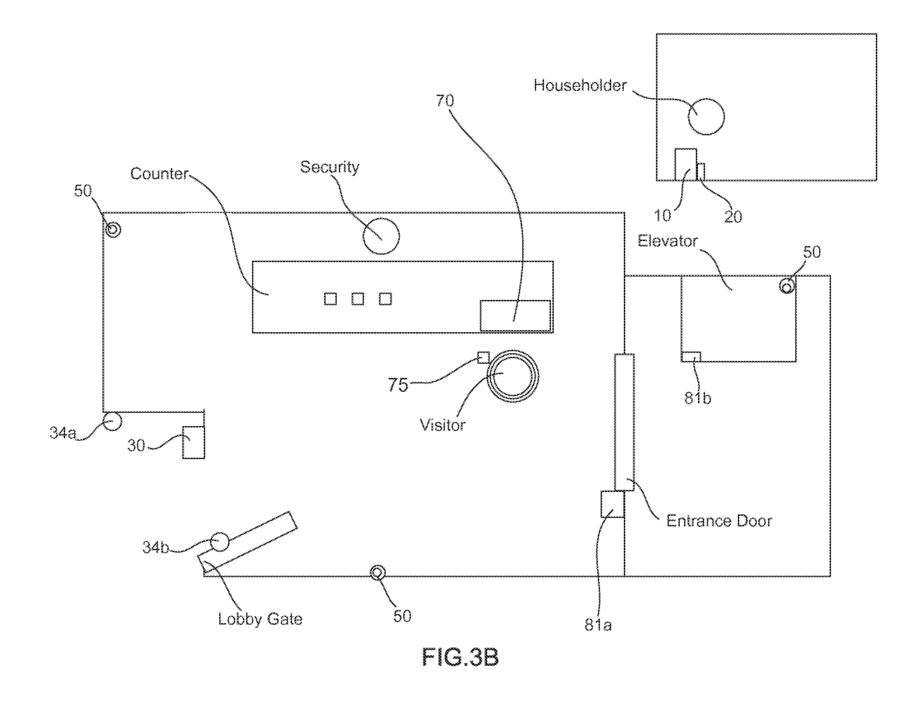

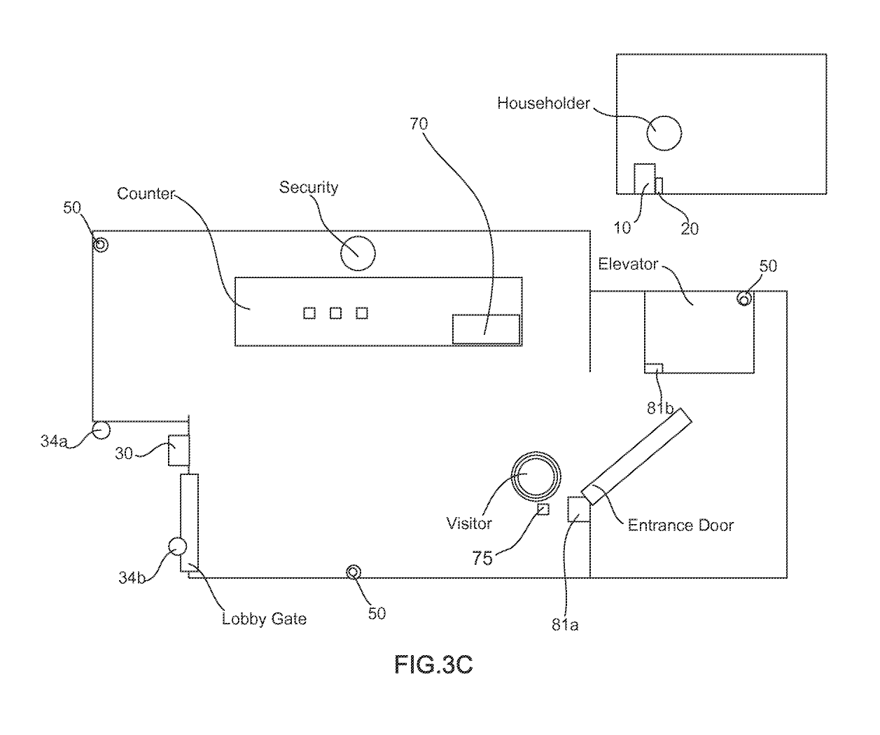

Please refer to FIG. 2 and FIG. 3A to FIG. 3C, there are shown an architectural diagram of the multi-scene monitoring system provided by the present invention, and a schematic diagram of the system applied in a community. The monitoring system includes an internal communication device 10, a warning module 20, a gate-end operating device 30, and a card authenticating device 70.

The internal communication device 10 is disposed in the internal of one house of the householder and includes: a first processing unit 11, an data receiving unit 12, a display module 13, a video switching module 14, an indoor communication module 15, a unlock unit 16, and a visitor identity confirming unit 17; wherein the data receiving unit 12, the display module 13, the video switching module 14, the indoor communication module 15, the unlock unit 16, and the visitor identity confirming unit 17 are connected to the first processing unit 11, moreover, the indoor communication module 15 is disposed for providing a householder to get communication with a visitor. Furthermore, the warning module 20 is disposed on the internal communication device 10 and controlled by the first processing unit 11 to send out warning messages, besides, the unlock unit is disposed for the householder to unlock the lobby gate.

The gate-end operating device 30 is disposed on the outside of a lobby gate of a community, and includes: a second processing unit 31, a driving unit 32, a gate-end camera module 33, two outdoor camera module (34a, 34b), and an outdoor communication module 35; wherein the second processing unit 31 is connected to the first processing unit 11 through an internet 60, and the driving unit 32 is connected to the second processing unit 31 for providing the visitor to activate the warning module 20.

Moreover, the gate-end camera module 33 is connected to the second processing unit 31 for capturing a video of the visitor, and the two outdoor camera module (34a, 34b) are disposed at a particular position around the lobby gate and connected to the second processing unit 31 of the gate-end operating device 30; furthermore, the outdoor communication module 35 is connected to the second processing unit 31 and providing for the visitor to get communication with the householder.

Besides, the gate-end operating device 30 further comprises an input unit 36 and a display module 37, therefore, the visitor can connect to the householder through dialing particular numbers on the input unit so as to notify the host through the driving unit and the warning module; moreover, the visitor can obtain response messages from the householder through the display module.

The card authenticating device 70 is disposed in the community and includes: a third processing unit 72, a confirming camera module 73, a confirming communication module 74 and a token card setting unit 71; wherein the third processing unit 72 is connected to the first processing unit through the internet 60, and the confirming camera module 73 is connected to the third processing unit 72 for capturing a video of the visitor.

Moreover, the confirming communication module 74 is connected to the third processing unit 72 and providing for the visitor to get communication with the householder, and the token card setting unit 71 is connected to the third processing unit 72 for setting a plurality of wireless transceiver addresses and a plurality of device IDs in a visitor token card 75; wherein the visitor can get the guest token card 75 from a lobby counter of the community after entering the lobby.

When the visitor is allowed to operate the card authenticating device 70 through the visitor token card 75, the visitor can get communication with the householder via the confirming communication module; such that the householder can confirm the identity of the visitor through the internal communication device; therefore, the householder can set at least one wireless transceiver address and at least one device ID in the visitor token card by operating the visitor identity confirming unit of the internal communication device; eventually, the visitor is allowed to use a plurality of community public equipment (Entrance Door, Elevator) based on the wireless transceiver address and the device ID set in the visitor token card.

Moreover, each the community public equipment (80a, 80b) comprises a card sensor (81a, 81b), such that the community public equipment (80a, 80b) can be activated after the visitor token card 75 is verified by the card sensor (81a, 81b).

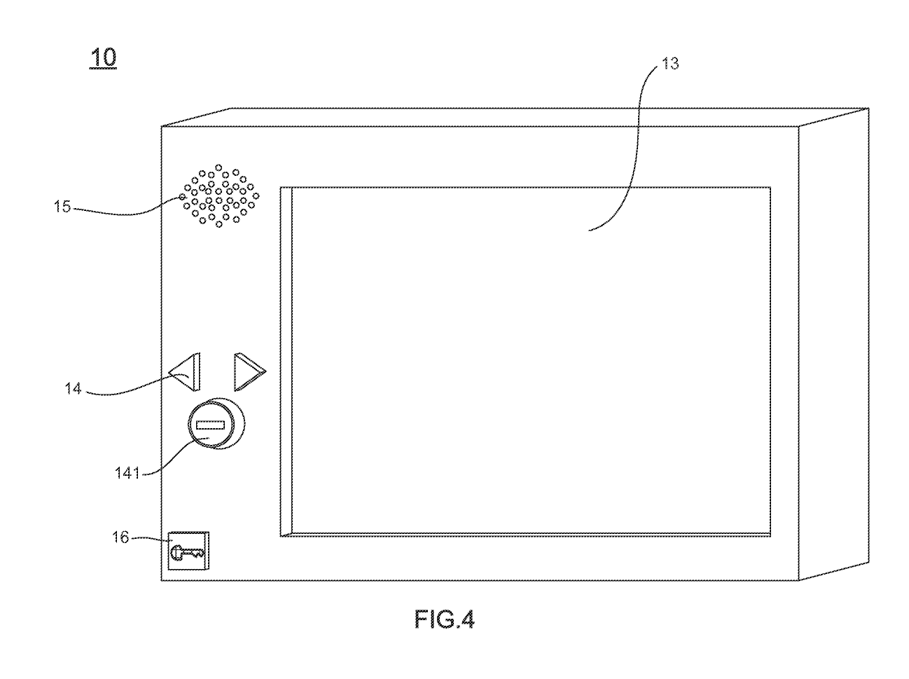

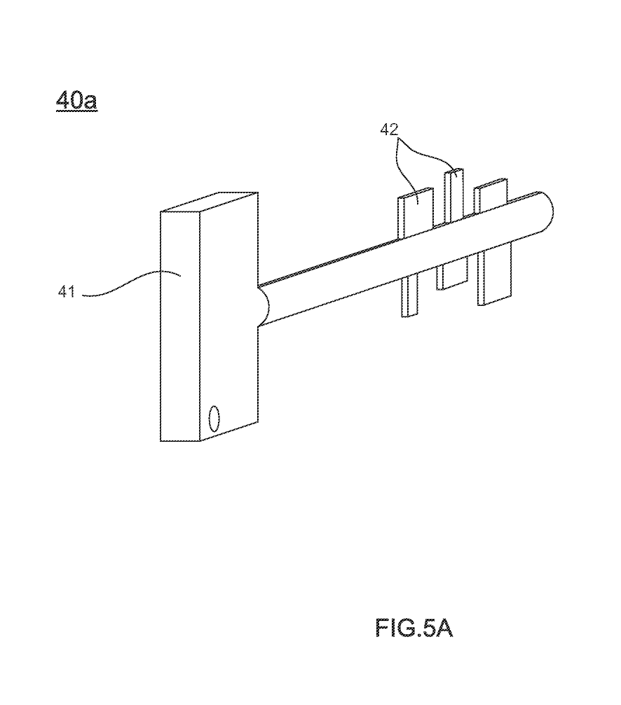

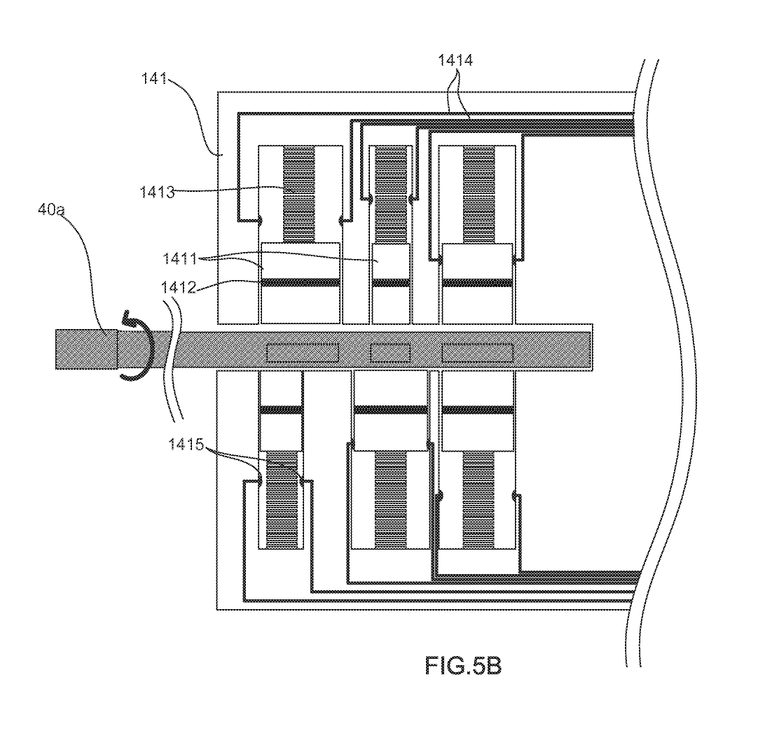

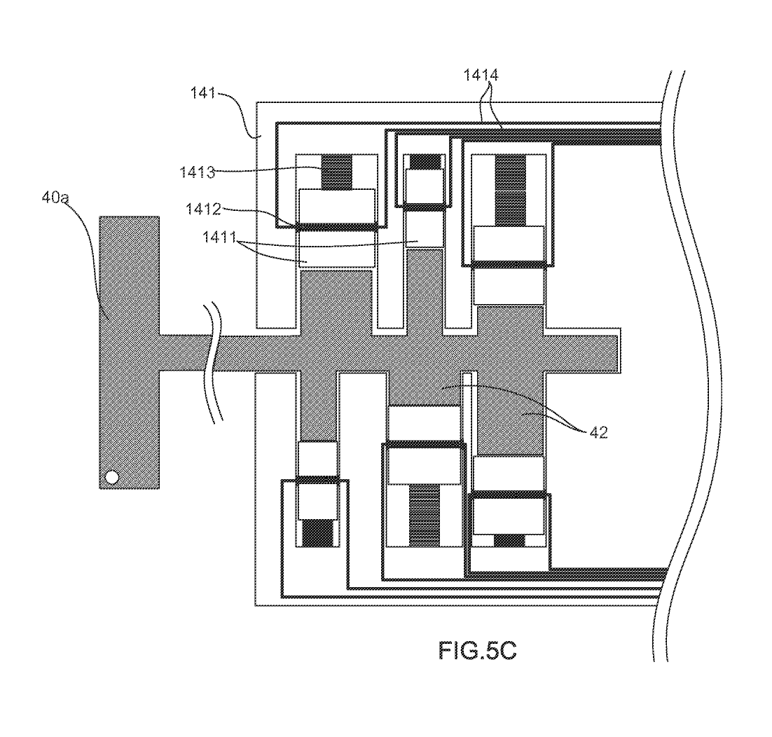

With reference to FIG. 3A, please simultaneously refer to FIG. 4 and FIG. 5A to FIG. 5C, show the stereo view of the internal communication device and the schematic diagram of the operation of the switching key and the switching keyhole. As the figures show, the display module of the internal communication device 10 is a touch panel, and the visitor identity confirming unit can be controlled via the touch panel;

moreover, the video switching module comprises a switching keyhole 141 for receiving a switching key 40a.

Wherein the switching key 40a comprises a plurality of peaks 42, accordingly, the switching keyhole 141 comprises a plurality of sliding blocks 1414 and a plurality of springs 1413, moreover, each sliding block 1414 is formed with a connecting bar 1412 for connecting and conducting the activating circuits 1414.

A plurality of community cameras 50 are disposed in the community and connected to the first processing unit via a plurality of activating circuits 1414 of the switching keyhole 141 respectively; wherein when the switching key 40a is inserted into the switching keyhole 141 and turned, the peak 42 of the switching key 40a can push the sliding block 1414 to a particular position so as to connecting the connecting bar 1412 and one of the activating circuits 1414, therefore, the householder can watch and switch videos shot by community cameras based on the activating circuit 1414.

Moreover, each the activating circuit 1414 comprises two elastic terminals 1415 for respectively connecting with both sides of the connecting bar 1412, and the switching key further comprises a handgrip portion 41.

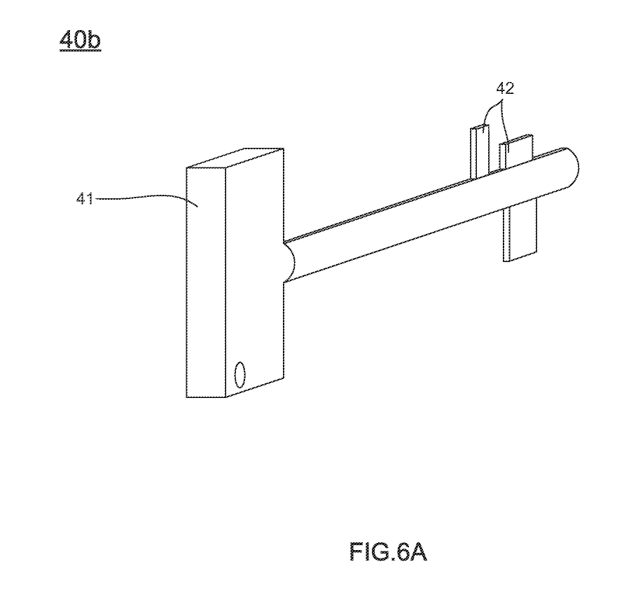

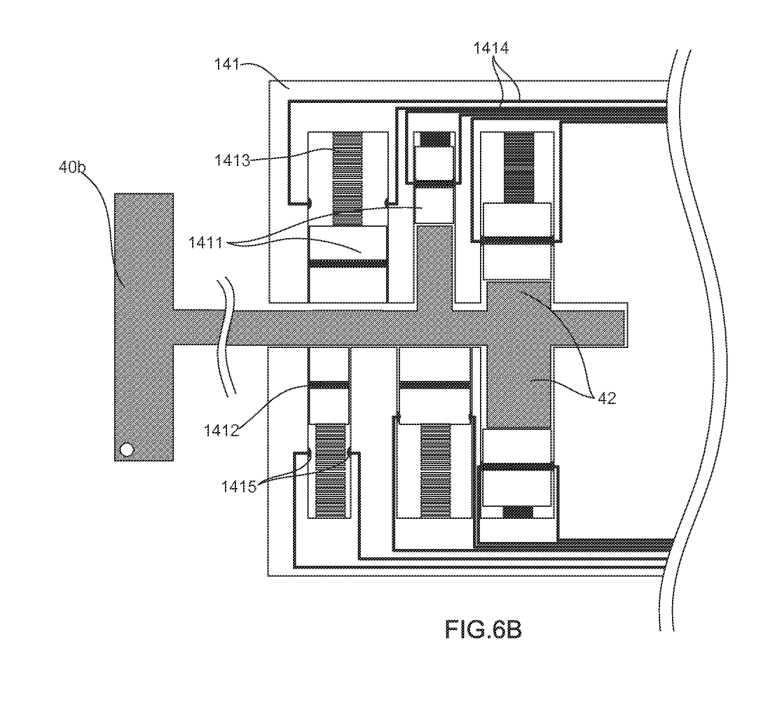

Please refer to FIG. 6A to FIG. 6B, show the schematic diagram of the operation of the switching key and the switching keyhole of the implemental embodiment. As the figure shows, the numbers of the peaks of the switching key 40b is three, therefore, the switching key 40b just can push three sliding blocks 1414 to the particular position so as to connecting the connecting bar 1412 and three of the activating circuits 1414, therefore, the householder with the switching key 40b can watch and switch fewer videos than the householder with the switching key 40a.

For example, the householder with the switching key 40a might be a member of the community management committee and the householder with the switching key 40b might be a general resident, such that the technique of the switching module in the present invention not only increase the convenience of the internal communication device, but also keep the privacy of the community householders.

By the detailed description of the overall structure and technical content of the present invention, the following advantages of the present invention can be derived:

(1) The system of the present invention employs the internet as a medium, thus the installation and maintenance costs can be decreased without spending a lot of money, time and manpower to install concrete wires.

(2) The present invention provides the householder to confirm identity of visitor with multiple perspectives so as to increase the home safety of the community.

(3) Through the card authenticating device and the visitor token card, visitors can use community public equipment by themselves so as to decrease the duty of security and increase the home safety again.

The above description is made on embodiments of the present invention. However, the embodiments are not intended to limit scope of the present invention, and all equivalent implementations or alterations within the spirit of the present invention still fall within the scope of the present invention.

What is claimed is:

1. A multi-scene monitoring system, being applied in a community consisted of a plurality of householders, and comprising:
an internal communication device, being disposed in the internal of one house of the householder, and comprising:
a first processing unit;
an data receiving unit, being connected to the first processing unit ;
a display module, being connected to the data receiving unit;
a video switching module, being connected to the first processing unit and comprising a switching keyhole for receiving a switching key;
an indoor communication module, being connected to the first processing unit and providing for a householder to get communication with a visitor; and
a visitor identity confirming unit;
a warning module, being disposed in the internal of one house of the householder and controlled by the first processing unit to send out warning messages;
a plurality of community cameras, being disposed in the community and connected to the first processing unit via a plurality of activating circuits of the switching keyhole respectively;
a gate-end operating device, being disposed on the outside of a lobby gate of a community, and comprising:
a second processing unit, being connected to the first processing unit through the internet;
a driving unit, being connected to the second processing unit for providing the visitor to activate the warning module;
a gate-end camera module, being connected to the second processing unit for capturing a video of the visitor;
at least one outdoor camera module, being disposed at a particular position around the lobby gate and connected to the second processing unit of the gate-end operating device; and
an outdoor communication module, being connected to the second processing unit and providing for the visitor to get communication with the householder; and
a card authenticating device, being disposed in the community and comprising:
a third processing unit, being connected to the first processing unit through the internet;
a confirming camera module, being connected to the third processing unit for capturing a video of the visitor;
a confirming communication module, being connected to the third processing unit and providing for the visitor to get communication with the householder; and
a token card setting unit, being connected to the third processing unit for setting a plurality of wireless transceiver addresses and a plurality of device IDs in a visitor token card;
wherein the switching key comprises at least one peak, accordingly, the switching keyhole comprises at least one sliding block, moreover, the sliding block is formed with a connecting bar for connecting and conducting the activating circuits;
wherein when the switching key is inserted into the switching keyhole and turned, the peak of the switching key can push the sliding block to a particular position so as to connecting the connecting bar and all of the activating circuits, therefore, the householder can watch and switch all videos shot by community cameras based on the activating circuit, wherein the visitor can get the guest token card from a lobby counter of the community after entering the lobby;
wherein when the visitor is allowed to operate the card authenticating device through the visitor token card, the visitor can get communication with the householder via the confirming communication module; such that the householder can confirm the identity of the visitor through the internal communication device; therefore, the householder can set at least one wireless transceiver address and at least one device ID in the visitor token card by operating the visitor identity confirming unit of the internal communication device; eventually, the visitor is allowed to use a plurality of community public equipment based on the wireless transceiver address and the device ID set in the visitor token card.

2. The multi-scene monitoring system of claim 1, wherein the gate-end operating device further comprises an input unit, therefore, the visitor can connect to the householder through dialing particular numbers on the input unit so as to notify the host through the driving unit and the warning module.

3. The multi-scene monitoring system of claim 1, wherein gate-end operating device further comprises a display module, such that the visitor can obtain response messages from the householder through the display module.

4. The multi-scene monitoring system of claim 1, wherein the warning module is disposed on the internal communication device.

5. The multi-scene monitoring system of claim 1, wherein the internal communication device further comprises an unlock unit for the householder to unlock the lobby gate.

6. The multi-scene monitoring system of claim 1, wherein each the community public equipment comprises a card sensor, such that the community public equipment can be activated after the visitor token card is verified by the card sensor.

7. The multi-scene monitoring system of claim 1, wherein the display module of the internal communication device is a touch panel, and the visitor identity confirming unit can be controlled via the touch panel.

8. The multi-scene monitoring system of claim 1, wherein the switching key further comprises a handgrip portion.

9. The multi-scene monitoring system of claim 1, wherein each the activating circuit comprises two elastic terminals for respectively connecting with both sides of the connecting bar.
